(19) United States
(12) Patent Application Publication
(10) Pub. No.: US 2026/0091836 A1
(43) Pub. Date: Apr. 2, 2026

(54) RECONFIGURABLE TRAILER

(71) Applicant: Edward J. Tovornik, JR., Frederick, MD (US)

(72) Inventor: Edward J. Tovornik, JR., Frederick, MD (US)

(21) Appl. No.: 19/343,399

(22) Filed: Sep. 29, 2025

Related U.S. Application Data
(60) Provisional application No. 63/701,229, filed on Sep. 30, 2024.

(51) Int. Cl. B62D 63/08

(52) U.S. Cl. CPC B62D 63/08

(57) ABSTRACT

A reconfigurable trailer system enables rapid equipment deployment for emergency response and utility work applications. The system includes a trailer with pivotable storage cabinets mounted to support frames that swing outwardly from trailer side walls, and removable fence sections positioned around the trailer perimeter with vertical posts insertable into post pockets. The pivoting storage cabinets provide immediate access to items stored behind them without requiring complete trailer unloading. Split ramp sections facilitate equipment loading and unloading operations. Methods include rapidly removing selected fence sections to create access openings, pivoting storage cabinets to extended positions for unobstructed equipment access, and deploying emergency response or utility equipment directly from configured access points. The system enables selective equipment access in space-constrained environments and dynamic reconfiguration during operations to adapt to changing work zone requirements, significantly reducing deployment time compared to conventional trailer systems in emergency response, road construction, and utility maintenance applications.

### CROSS-REFERENCE TO RELATED APPLICATION

This application claims the benefit of U.S. Provisional Patent Application No. 63/701,229, filed Sep. 30, 2024, entitled “Reconfigurable Trailer,” the entire disclosure of which is incorporated herein by reference.

### FIELD OF THE INVENTION

The present invention relates generally to towed trailers, and more particularly to trailers having reconfigurable wall portions and storage compartments to improve access to items stored on the trailer and deployment of items from the trailer for emergency response, road construction, utility work, and other applications requiring rapid equipment deployment.

### BACKGROUND OF THE INVENTION

Road, emergency response, and other work crews are frequently called upon to perform various operations at remote locations. Those operations may require that a work crew transport various equipment to the work zone, such as on a trailer that is often towed by a work vehicle. Of course, the equipment requirements vary significantly from job to job. Moreover, in certain emergency circumstances, deployment of a work crew's equipment may be critical to mitigate dangers to the public or to infrastructure, making ready, easy access to such equipment a critical priority. However, due to the fact that each situation requiring a work crew is different, the equipment needs to address such situations varies widely.

There remains a need for improved equipment access and deployment capabilities in trailer systems used for emergency response, road construction, and utility work applications.

In emergency response scenarios involving natural disasters or accidents, rapid equipment deployment is essential. When trailers contain various emergency tools and supplies, accessing specific equipment may require unloading multiple items, creating delays that can be detrimental when every second counts.

Moreover, road maintenance and construction crews frequently transport diverse equipment including signage, cones, and heavy machinery. Efficient organization and selective access to these items can be important for rapid deployment operations.

Even further, utility workers performing repairs in remote or spatially constrained locations would benefit from trailer systems that provide adaptable access to tools and materials based on the specific work environment requirements.

Thus, there remains a need for transportation systems, such as towed trailers, capable of providing enhanced equipment access and deployment capabilities optimized for particular work zone situations.

### SUMMARY OF THE INVENTION

In accordance with aspects of the present invention, a reconfigurable trailer system is provided that addresses the shortcomings of previously known trailer systems by enabling rapid, customized access to equipment and materials. The reconfigurable trailer system comprises a trailer with removable fencing panels positioned around the outer perimeter for easy access to trailer contents, pivotable storage cabinets that swing outward from the trailer sides to provide immediate access to items stored behind them, and split ramp sections for efficient loading and unloading operations.

The pivotable storage cabinets preferably include lockers and multi-compartment storage boxes as described in U.S. Pat. No. 10,160,373, mounted to support frames that are pivotably connected to the trailer via hinge assemblies. This configuration allows storage cabinets to swing outward in an arc from their stowed position alongside the trailer walls to an extended position providing clear access to items stored on the trailer floor behind the cabinets.

The removable fence sections comprise vertical fence posts configured for insertion into post pockets positioned along the trailer perimeter, with horizontal cross members and fence rails forming a secure containment system that can be quickly removed to access specific areas of the trailer.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a perspective view of a reconfigurable trailer system according to certain aspects of an embodiment of the invention.

FIG. 2 is a perspective view of the reconfigurable trailer system of FIG. 1 equipped with a second movable storage locker and storage cabinet.

FIG. 3 is a perspective view of the reconfigurable trailer system of FIG. 1 with deployed trailer ramps.

FIG. 4 is a further perspective view of the reconfigurable trailer system of FIG. 1.

FIG. 5 is a side view of the reconfigurable trailer system of FIG. 1.

FIG. 6 is a back end view of the reconfigurable trailer system of FIG. 1.

FIG. 7 is a top view of a support frame for supporting one or more storage cabinets in the trailer system of FIG. 1.

FIG. 8 is a perspective view of a hinge assembly and mounting system for mounting the support frame of FIG. 7.

FIG. 9 is a perspective view of a portion of the support frame of FIG. 7.

FIG. 10 is a perspective view of a fence section for use with the reconfigurable trailer system of FIG. 1.

FIG. 11 is a sectional view of a portion of the fence section of FIG. 10 and showing the profile of a fence section rail.

FIG. 12 is a perspective view of a fence section for use with the reconfigurable trailer system of FIG. 1 with an alternative configuration to accommodate a wheel well of the trailer.

FIG. 13 is a perspective view of a fender pocket bracket for use with the reconfigurable trailer system of FIG. 1 to hold the fence section of FIG. 12.

FIG. 14 is another back end view of the reconfigurable trailer system of FIG. 1 and showing details of the mounting system for the ramp sections.

FIG. 15 is a side, close-up view of the mounting system for the ramp sections of the reconfigurable trailer system of FIG. 1.

FIG. 16 is a detail perspective view of a ramp section for use with the reconfigurable trailer system of FIG. 1.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

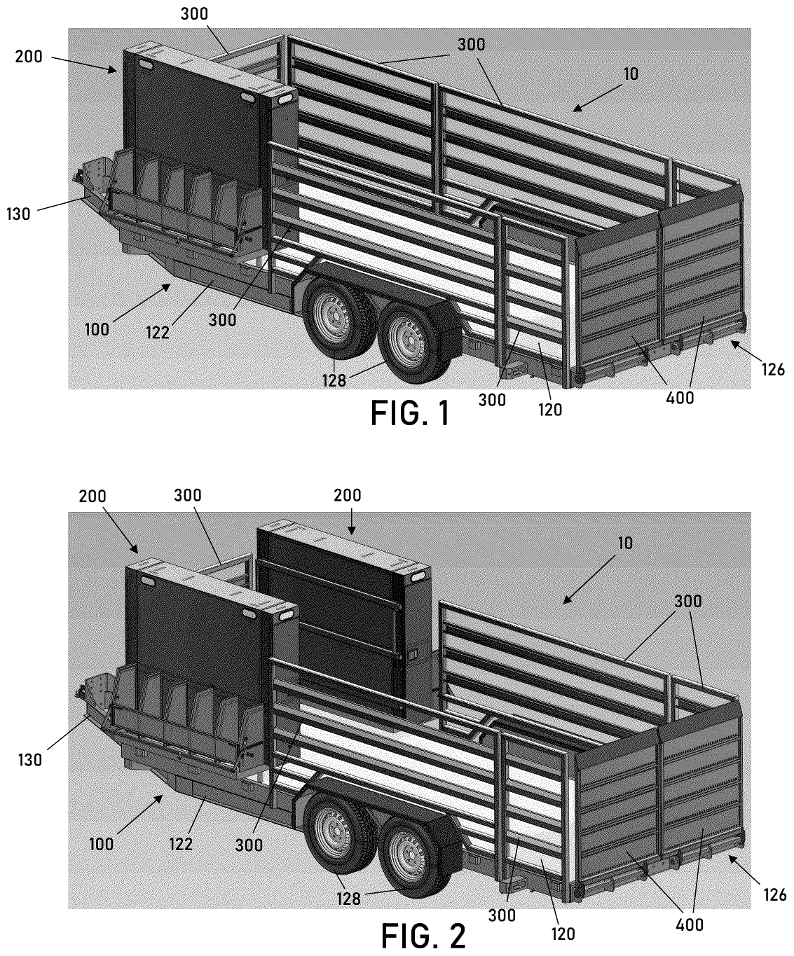

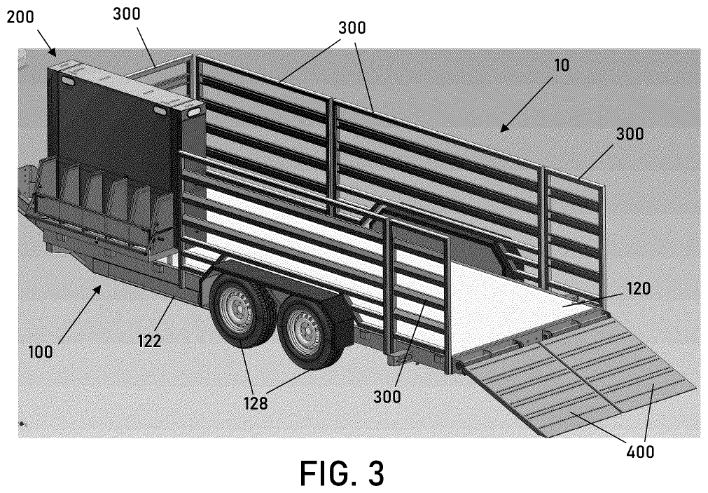

In accordance with certain aspects of an exemplary embodiment and with reference to FIGS. 1-3, a reconfigurable trailer system 10 is provided comprising a number of separate quick-remove fencing panels 300 removably placed around the outer perimeter of trailer 100 for easy access to the contents of trailer 100, and for easy deployment of work zone and emergency response equipment from trailer 100. The trailer system 10 may additionally include movable storage lockers and storage cabinets 200 (preferably including lockers 202 and multi-compartment storage boxes 204, as particularly described in U.S. Pat. No. 10,160,373, incorporated herein by reference) pivotably mounted to trailer 100 to both provide itemized storage of particular equipment items (e.g., signage, road sign stands, or such other equipment as may be desirable for a given application) while allowing immediate access to items stored on the trailer behind storage cabinets 200 by swinging those storage cabinets 200 outward from the side of the body of trailer 100. The trailer system 10 also preferably includes a trailer ramp section 400 including split ramps enabling ramped entry onto and exit from the interior of trailer 100. The trailer system 10 configured in accordance with aspects of the invention may be retrofitted to a wide variety of trailer frames.

A reconfigurable trailer system configured in accordance with at least certain aspects of the invention may address one or more shortcomings of previously known trailer systems across multiple commercial applications. In emergency response scenarios, operators can rapidly deploy equipment by first assessing the required equipment through visual inspection of labeled storage cabinets 200. Critical equipment such as traffic control devices and warning signs may be stored in storage cabinets positioned nearest the pivot points for immediate access. The operator may remove fence sections 300 adjacent to required equipment locations, and may do so quickly due to the quick-release post pocket system 112. Storage cabinets 200 are then pivoted outwardly, providing unobstructed access to trailer floor 120 behind the cabinets without requiring removal of unrelated equipment. Road construction crews benefit from the customized storage configurations and rapid access capabilities. Traffic control equipment, signage, and construction tools can be organized for immediate deployment, reducing setup time and improving worker safety in traffic environments. For utility repairs in spatially constrained locations, such as urban underground utility access points or roadside equipment installations, the reconfigurable trailer system 10 enables selective equipment access tailored to the specific work environment. By removing only fence sections 300 on the side of trailer 100 facing the work area, utility workers maintain equipment security on the opposite side while accessing required tools and materials. The pivoting storage cabinets 200 extend outwardly beyond the trailer perimeter, providing equipment access even when the trailer cannot be positioned optimally due to space limitations. During extended work operations, the trailer system 10 can be reconfigured as operational needs change without returning to a storage location. For example, after initial traffic control setup using equipment from one side of the trailer, storage cabinets 200 can be returned to stowed positions and different fence sections 300 removed to access equipment for secondary work phases. This dynamic reconfiguration capability enables work crews to adapt to changing operational requirements, weather conditions, or site access constraints during active operations.

With particular reference to FIGS. 1-5, in an exemplary configuration trailer 100 includes a trailer floor 120, trailer side walls 122 extending down from the trailer floor 120 on both sides of trailer 100, trailer front wall 124 extending down from the trailer floor 120 at the front of the trailer, trailer back wall 126 extending down from the trailer floor 120 at the back of the trailer, wheels 128 and hitch assembly 130 for attachment to a work vehicle to enable towing of trailer 100 to a work zone. The trailer floor 120 is preferably constructed of steel plate material providing sufficient strength to support heavy equipment loads while maintaining reasonable weight for towing efficiency. The trailer walls 122, 124, 126 may be constructed of steel or aluminum materials selected based on application requirements and weight considerations.

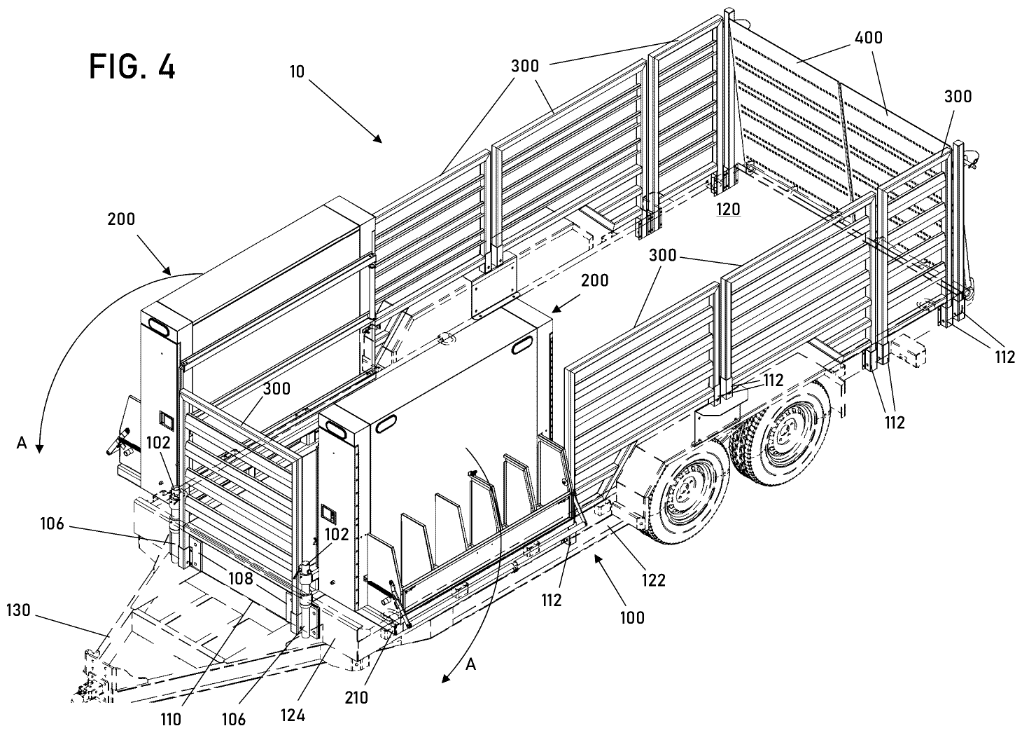

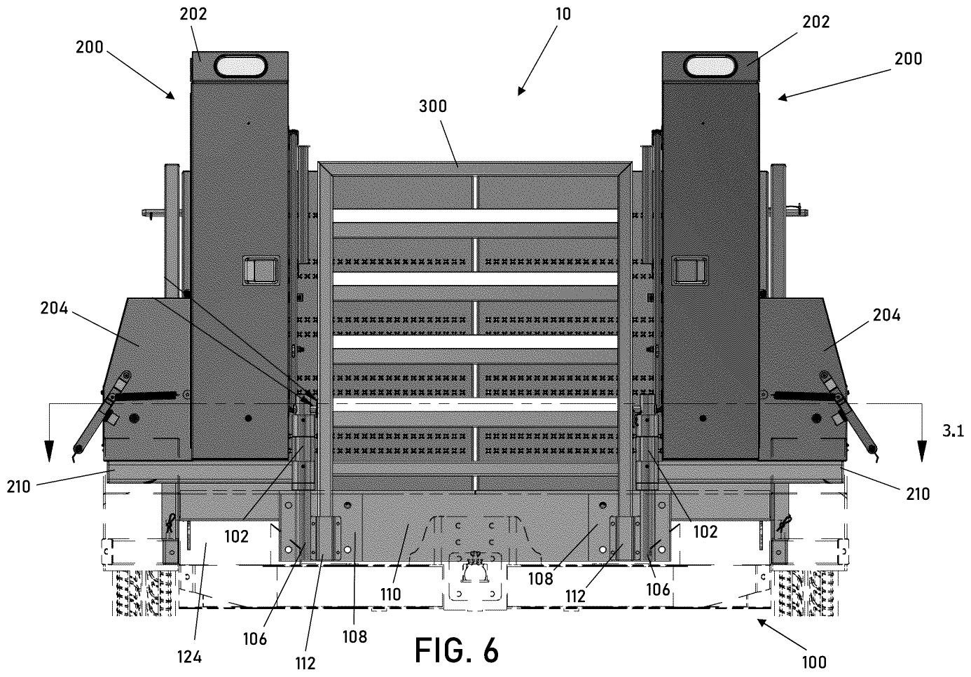

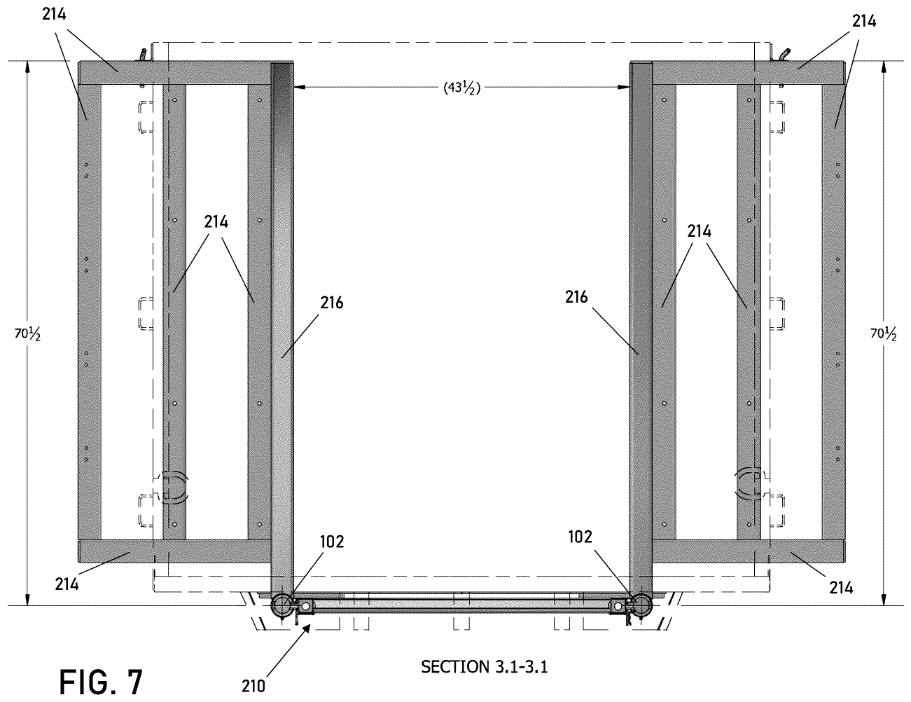

With particular reference to FIGS. 4-9, in an exemplary configuration support frames 210 are pivotably mounted to trailer front wall 124, and are particularly sized to hold and carry removably and pivotably mounted storage cabinets 200, enabling storage cabinets 200 to swing outward (in the direction of arrow A in FIG. 4) from the trailer side walls 122 to allow access to items stored on trailer floor 120 behind storage cabinets 200. In varying configurations, reconfigurable trailer system 10 may have a single support frame 210 and storage cabinet 200, two support frames 210 and storage cabinets 200 (as shown in FIGS. 2 and 4), three or more support frames and storage cabinets, or may be configured with support frames pivotally mounted to different locations on the trailer without departing from the scope of the invention. Each support frame 210 may comprise base frame members 214 forming a generally rectangular base sized to receive both the locker 202 and the multi-compartment storage box 204 of a storage cabinet 200. In an exemplary configuration, storage cabinet 200 may be removably affixed to support frame 210, such as by way of threaded fasteners such as screws or bolts that may be removed when an operator desires to replace a storage cabinet 200 with a fence section 300. The inner-most base frame member 214 is affixed to a pivot arm 216 that in turn is mounted to a hinge rod 102 on the trailer front wall 124. Preferably, both upper and lower pivot arms 216 are provided for each support frame 210, each pivot arm 216 being pivotably mounted on hinge rod 102. Such a formation of upper and lower pivot arms 216 forms a back vertical wall of each support frame 210 that supports the lower back portion of each locker 202, aiding in providing support and stability to locker 202.

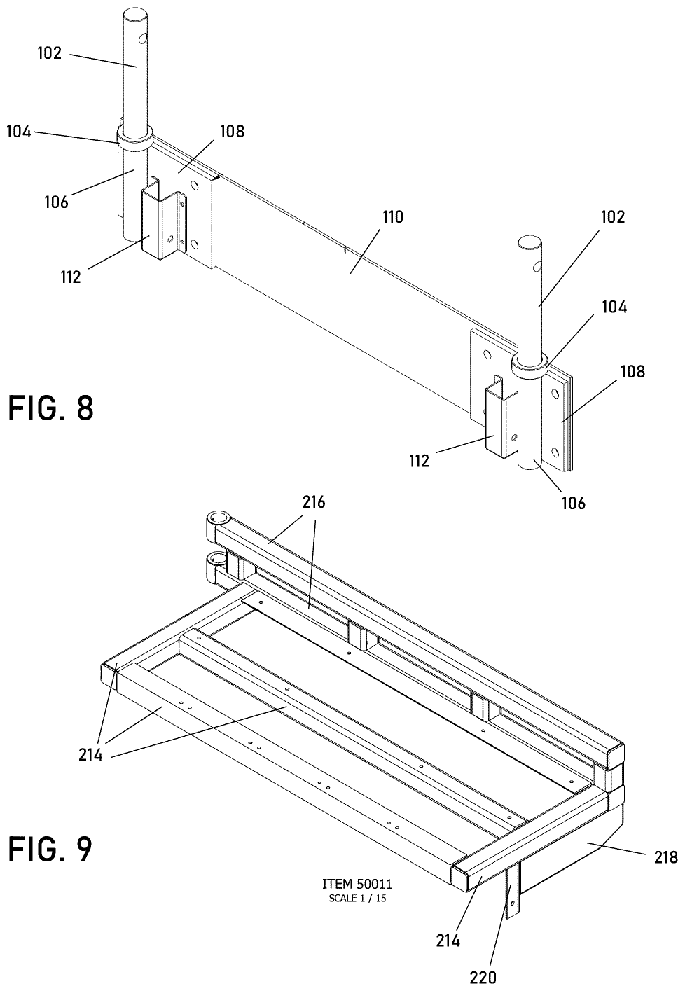

As shown in detail in FIG. 8, hinge rod 102 extends upward from a hinge rod support 106 and is attached to hinge rod support 106 via a lock bushing 104. Hinge rod support 106 in turn is preferably affixed to a hinge plate 108, and hinge plate 108 is affixed to a front trailer plate 110 on, for example, trailer front wall 124, such as by welding or such other manner of fixation as may occur to those skilled in the art. A post pocket 112 is mounted preferably to each hinge plate 108 to each receive a vertical fence post 302 of a removably mounted fence section 300. This dual-purpose mounting system allows the same mounting points to accommodate either pivoting storage cabinets or removable fence sections, providing maximum configurability.

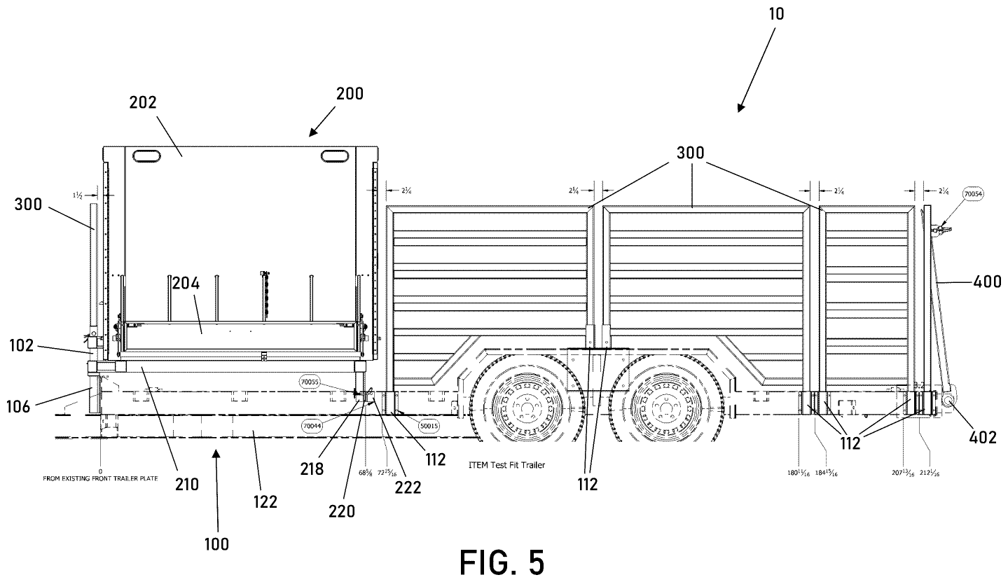

A rear base frame member 214 is preferably provided a downwardly extending frame rest 218 that serves to hold support frame 210 above trailer floor 120 when storage cabinet is in its stowed position in line with the side of trailer 100. Further, a rest stiffener 220 is affixed to frame rest 218, and preferably to the underside of the rear base frame member 214, to both provide an added structural support to frame rest 218 and a locking mechanism to lock support frame 210 in a stowed position. More particularly, rest stiffener 220 is provided an opening that aligns with an opening in a rest locking angle 222 (FIG. 5) that is affixed to trailer side wall 122, such that a removable pin may be inserted through the aligned holes to lock support frame 210 in place in its stowed position, such as when the trailer system 10 is being towed from a storage location to a work zone, and vice versa.

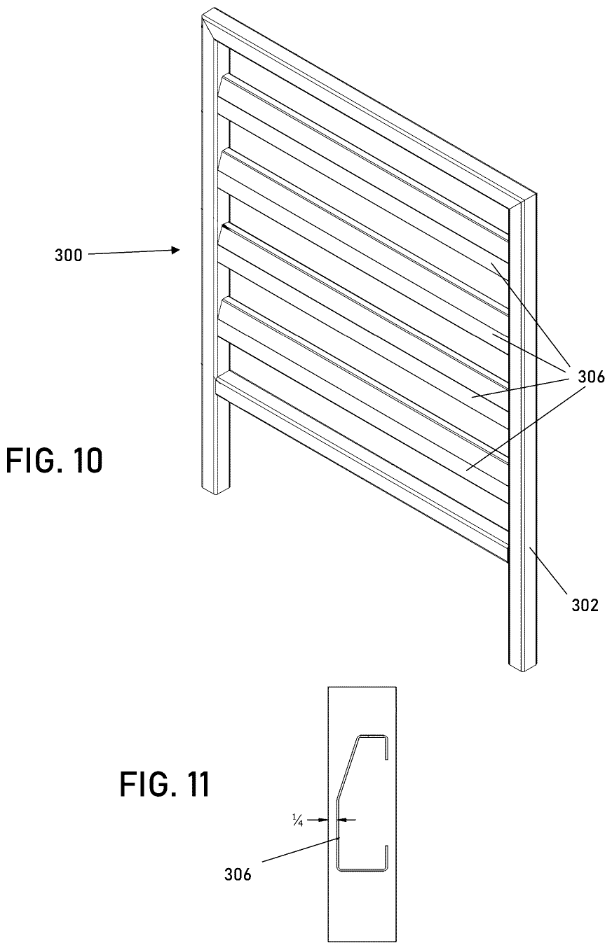

With reference to FIGS. 10-13, removably mounted fence sections 300 each preferably comprise vertical fence posts 302 at the outer sides, which vertical fence posts 302 are configured for insertion into post pockets 112 positioned along trailer side walls 122 and trailer front wall 124. Removably mounted fence sections 300 further comprise horizontal fence section cross members 304 extending between vertical fence posts 302 to form a frame for fence section 300. One or more fence section rails 306 are provided extending between and affixed to each vertical fence post 302, vertically aligned between fence section cross members 304. Fence section rails 306 may have a cross section as shown in FIG. 11 to provide a sizeable vertical surface for fencing in equipment stored on trailer 100 but while maintaining minimal weight for ease of removal of fence sections 300 when desired, such as to access equipment stored behind a given fence section 300.

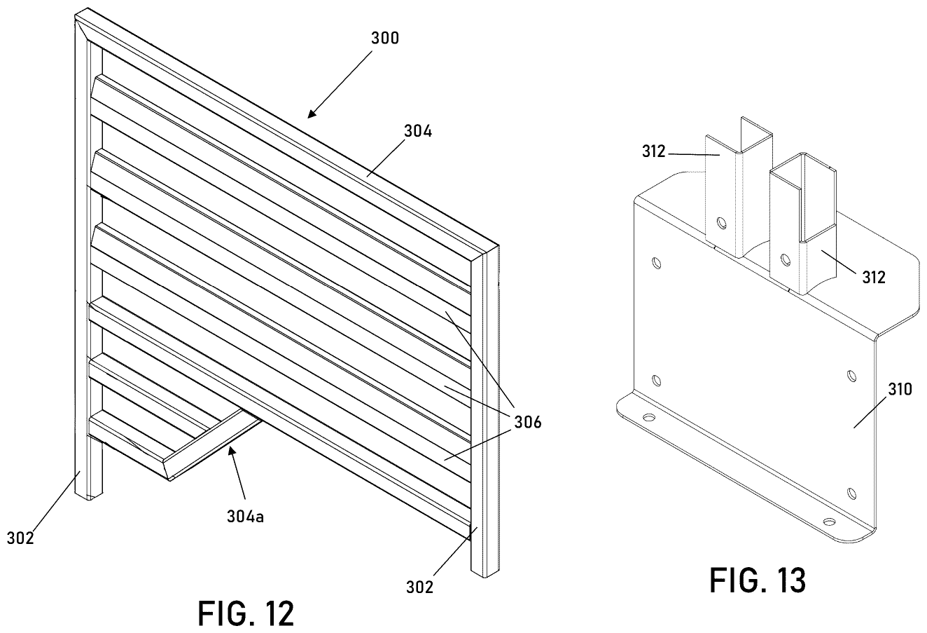

In order to fence the wall of trailer 100 above the wheel well, and with particular reference to FIGS. 12 and 13, a fender pocket bracket 310 may be provided and affixed to the interior wall of each wheel well, which fender pocket bracket 310 positions fender post pockets 312 generally in horizontal alignment with post pockets 112 positioned on the same side of trailer 100. A fence section 300 may be modified to include a stepped fence section cross member 304a at the bottom of the fence section 300, which stepped fence section cross member 304a continues to provide a rigid frame for fence section 300 while being contoured to fit closely against or adjacent to the wheel well of trailer 100.

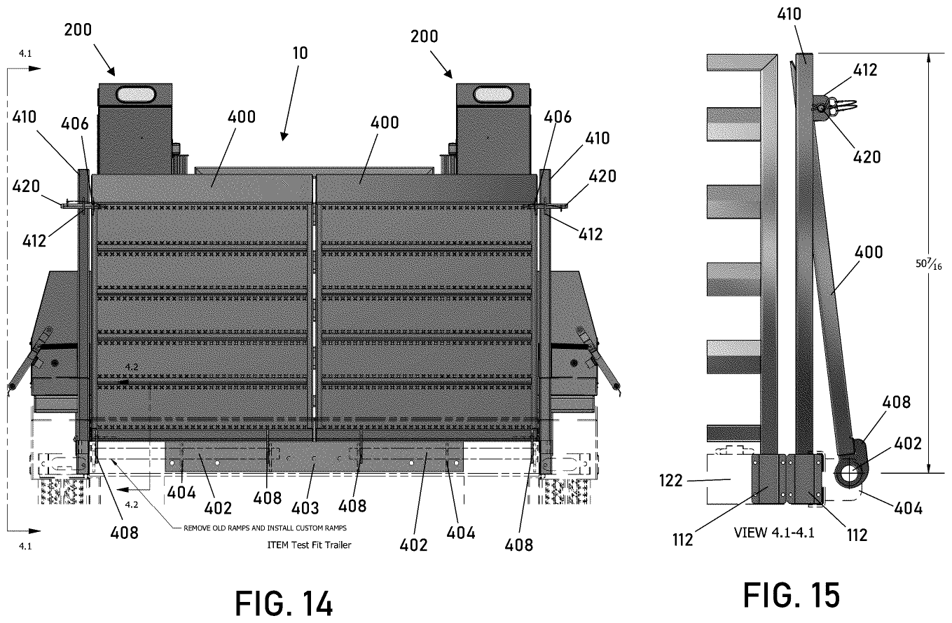

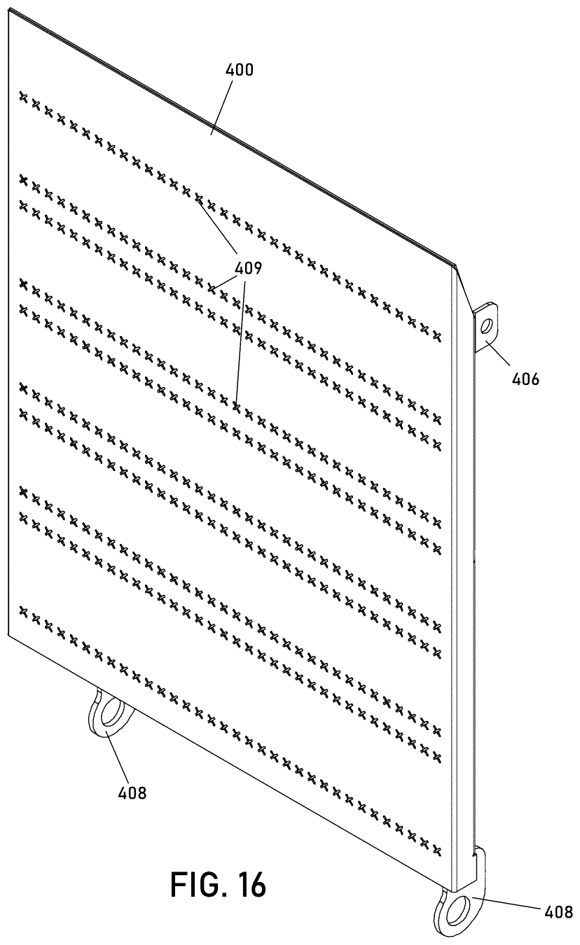

With reference to FIGS. 14-16, trailer ramp sections 400 are provided at the back of trailer 100. Trailer ramp sections 400 are pivotally mounted to trailer 100 at ramp support bars 402 that extend horizontally across the trailer back wall 126 and held in place by ramp support bar mounting plates 404 that extend rearward from and are aligned with trailer side wall 122. A trailer back plate 403 may be affixed to trailer back wall 126 and provide additional ramp support bar mounting plates 404 for added support. Trailer ramp sections 400 may each include a ramp support bar mounting plate 408 having an opening extending therethrough that receives ramp support bar 402 to pivotally mount each trailer ramp section 400 to its respective ramp support bar.

The reconfigurable trailer system may be implemented in numerous alternative configurations to meet specific application requirements. The system may be configured with pivoting storage cabinets on only one side of the trailer, with the opposite side having fixed fence sections or storage compartments. Three or more pivoting storage cabinets may be mounted along the length of the trailer sides, each independently operable to provide selective access to different storage zones. Different sizes and configurations of storage cabinets may be interchanged based on mission requirements, including specialized cabinets for medical equipment, hazardous materials, or oversized tools. Some mounting points may accommodate quick-change systems allowing rapid conversion between fence sections and storage cabinets without tools. The split ramp system may be configured with additional ramp sections for specialized loading requirements, or with integrated tie-down systems for securing equipment during transport.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

1. A reconfigurable trailer system comprising:
a trailer having a floor, a front wall, a rear wall, and opposed side walls;
at least one support frame pivotably mounted to said trailer;
at least one storage cabinet mounted to said support frame, wherein said support frame is configured to pivot said storage cabinet between a stowed position adjacent one of said side walls and an extended position displaced outwardly from said side wall to provide access to items stored on said trailer floor behind said storage cabinet; and
a plurality of removable fence sections configured for selective installation around a perimeter of said trailer, each fence section comprising vertical fence posts configured for insertion into post pockets mounted to said trailer.

2. The reconfigurable trailer system of claim 1, wherein said support frame comprises:
base frame members forming a rectangular base configured to receive said storage cabinet;
at least one pivot arm affixed to said base frame members; and
a hinge rod mounted to said trailer and configured to pivotably receive said pivot arm.

3. The reconfigurable trailer system of claim 2, further comprising:
a hinge rod support affixed to said trailer;
a hinge plate mounted between said hinge rod support and said trailer; and
a post pocket mounted to said hinge plate and configured to receive a vertical fence post of one of said removable fence sections.

4. The reconfigurable trailer system of claim 1, wherein said storage cabinet comprises:
a locker having a closeable compartment; and
a multi-compartment storage box having a plurality of open storage compartments.

5. The reconfigurable trailer system of claim 1, further comprising a locking mechanism configured to secure said support frame in said stowed position, said locking mechanism comprising:
a frame rest extending downwardly from said support frame;
a rest locking angle affixed to said side wall; and
a removable pin configured for insertion through aligned openings in said frame rest and said rest locking angle.

6. The reconfigurable trailer system of claim 1, wherein said removable fence sections comprise:
vertical fence posts positioned at opposed ends of each fence section;
horizontal cross members extending between said vertical fence posts; and
fence rails extending between and affixed to said vertical fence posts.

7. The reconfigurable trailer system of claim 6, further comprising:
a fender pocket bracket affixed to a wheel well of said trailer; and
fender post pockets mounted to said fender pocket bracket and configured to receive shortened vertical fence posts of fence sections adapted for installation adjacent said wheel well.

8. The reconfigurable trailer system of claim 1, further comprising:
split ramp sections pivotably mounted to said rear wall of said trailer;
ramp support bars extending horizontally across said rear wall; and
ramp support bar mounting plates configured to pivotably mount said ramp sections to said ramp support bars.

9. The reconfigurable trailer system of claim 8, wherein each of said ramp sections comprises:
a ramp support bar mounting plate having an opening configured to receive one of said ramp support bars;
a non-skid surface on a top surface of said ramp section; and
a ramp pin receiver configured to engage with a locking mechanism when said ramp section is in a stowed position.

10. The reconfigurable trailer system of claim 1, further comprising:
a hinge rod extending vertically along said front wall of said trailer;
wherein said support frame pivots about said hinge rod between said stowed position and said extended position.

11. The reconfigurable trailer system of claim 1, wherein said post pockets are positioned at multiple locations along said perimeter of said trailer to enable selective installation of said removable fence sections in various configurations.

12. The reconfigurable trailer system of claim 1, further comprising at least one additional support frame pivotably mounted to said trailer at a location different from said first support frame, enabling multiple independent access points to items stored on said trailer floor.

13. The reconfigurable trailer system of claim 1, wherein said trailer is configured for retrofit installation onto standard vehicle frames used in emergency response, road construction, and utility maintenance applications.

14. A method of deploying emergency response equipment from a reconfigurable trailer comprising:
transporting said trailer to an emergency response location, said trailer having pivotable storage cabinets containing emergency equipment and removable fence sections around a perimeter thereof;
removing at least one of said removable fence sections to create immediate access to critical emergency equipment stored on said trailer;
pivoting at least one of said storage cabinets outwardly to provide unobstructed access to emergency equipment stored behind said storage cabinet; and
deploying said emergency equipment directly from said trailer without requiring complete unloading of said trailer contents.

15. The method of claim 14, wherein said emergency equipment comprises traffic control devices, warning signs, emergency medical supplies, or disaster response equipment.

16. A method of rapid work zone setup comprising:
deploying a reconfigurable trailer system to a work zone requiring equipment deployment;
configuring said trailer for equipment access by pivoting storage cabinets containing equipment to extended positions and removing fence sections adjacent to equipment deployment areas;
establishing traffic control or emergency response operations using equipment accessed through said configured trailer system; and
reconfiguring said trailer system during operations by repositioning said storage cabinets and fence sections to access different equipment as operational needs change.

17. The method of claim 16, wherein said equipment deployment further comprises:
selectively removing fence sections from areas of said trailer corresponding to required utility equipment while maintaining fence sections in areas containing equipment not needed for immediate deployment;
accessing utility tools and materials through said selectively opened areas without disturbing equipment in secured areas of said trailer; and
retrieving said utility tools and materials for utility infrastructure repair or maintenance operations.
